(19) United States
(12) Patent Application Publication
(10) Pub. No.: US 2010/0025500 A1
(43) Pub. Date: Feb. 4, 2010

(54) Materials for fuel injector components

(75) Inventors: Michael J. Pollard, Peoria, IL (US); Petr Michlik, East Peoria, IL (US); Jeff A. Jensen, Dunlap, IL (US); Scott A. Johnston, East Peoria, IL (US); Pingshun Zhao, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: CATERPILLAR INC.

(21) Appl. No.: 12/219,977

(22) Filed: Jul. 31, 2008

(51) Int. Cl. F02M 61/10; B23P 15/00; F02M 61/16

(52) U.S. Cl. 239/584; 29/890.12

(57) ABSTRACT

A fuel injector is disclosed. The fuel injector has an injector body and an injector needle located inside the injector body. At least one of the injector body and injector needle has a portion configured to be exposed to a combustion chamber, the portion including maraging or carburizing steel and having a nitrided outer layer.

### TECHNICAL FIELD

The present disclosure is directed to a fuel injector and, more particularly, to materials for a fuel injector.

### BACKGROUND

As government regulations for exhaust emissions become more stringent, manufacturers may have to develop combustion engines that produce emissions that are lower than current levels. One method for reducing combustion engine emissions is to use more efficient engines having higher fuel injection pressures and temperatures such as, for example, engines having direct injectors with small orifice sizes. Higher combustion temperatures and pressures may cause conventional fuel injector materials to soften and/or be excessively stressed, possibly leading to improper operation. Because fuel injector components are subjected to a high number of load cycles during a design life such as, for example, billions of load cycles, fatigue failure of current materials due to higher temperatures and pressures may be particularly problematic.

U.S. Pat. No. 6,168,095 (the '095 patent) issued to Seitter et al discloses the particular materials used in forming a portion of a fuel injector. The '095 patent discloses a fuel injector for an internal combustion engine having a nozzle body that supports a movable valve needle. An outer surface of the nozzle body facing the combustion chamber and an inner surface of the nozzle body supporting the valve needle are hardened with the use of nitrogen.

Although the fuel injector of the '095 patent may provide materials for a fuel injector, it may fail to prevent softening and fatigue failure at the higher pressures and temperatures required to increase engine efficiency and to reduce exhaust emissions to required levels.

The present disclosure is directed to overcoming one or more of the shortcomings set forth above and/or other deficiencies in the art.

### SUMMARY OF THE DISCLOSURE

In accordance with one aspect, the present disclosure is directed toward a fuel injector. The fuel injector includes an injector body and an injector needle located inside the injector body. At least one of the injector body and injector needle has a portion configured to be exposed to a combustion chamber, the portion including maraging or carburizing steel and having a nitrided outer layer.

According to another aspect, the present disclosure is directed toward a method for processing a fuel injector component. The method include machining at least a portion of a fuel injector component formed of maraging steel and nitriding the fuel injector component during an aging process.

### BRIEF DESCRIPTION OF THE DRAWINGS

FIG. 1 is a schematic illustration of a portion of an exemplary disclosed engine;

FIG. 2 is a schematic illustration of an exemplary disclosed fuel injector nozzle;

FIG. 3 is a flow chart for an exemplary disclosed processing method; and

FIG. 4 is another flow chart for the exemplary disclosed processing method.

### DETAILED DESCRIPTION

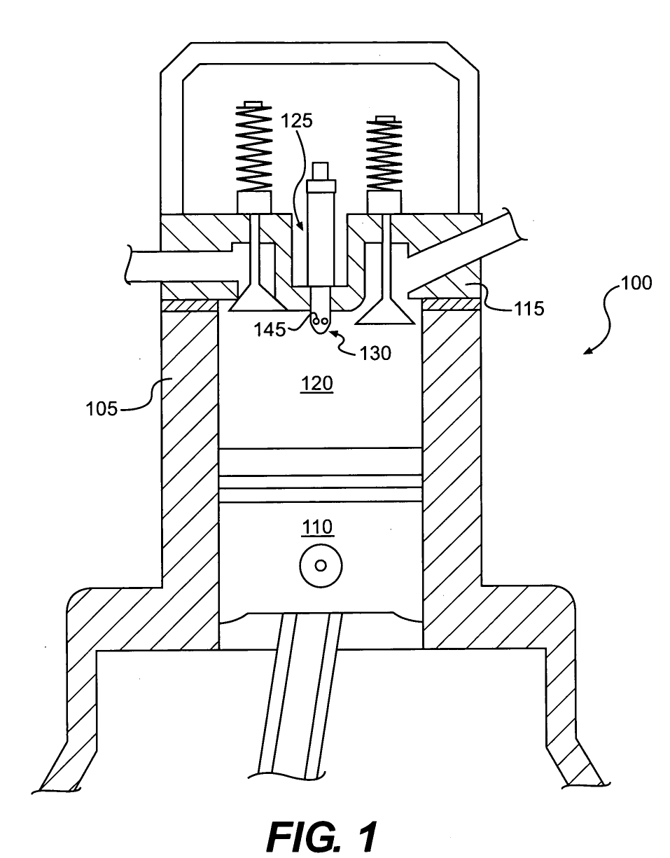

FIG. 1 illustrates a portion of an exemplary engine 100 that may be a four-stroke diesel or gasoline engine, or a gaseous fuel-powered engine. Engine 100 may include at least one cylinder 105, piston 110, and cylinder head 115, which may together form at least one combustion chamber 120. Engine 100 may also include at least one fuel injector 125 to inject fuel into combustion chamber 120 to contribute to combustion within engine 100. Fuel injector 125 may inject fuel into combustion chamber 120 via any suitable technique known in the art such as, for example, direct injection.

Fuel injector 125 may inject fuel directly into combustion chamber 120 without pre-mixing the fuel with air prior to injection via an intake manifold. Because fuel injector 125 may directly inject fuel into combustion chamber 120, a portion 130 of fuel injector 125 may be exposed to combustion chamber 120.

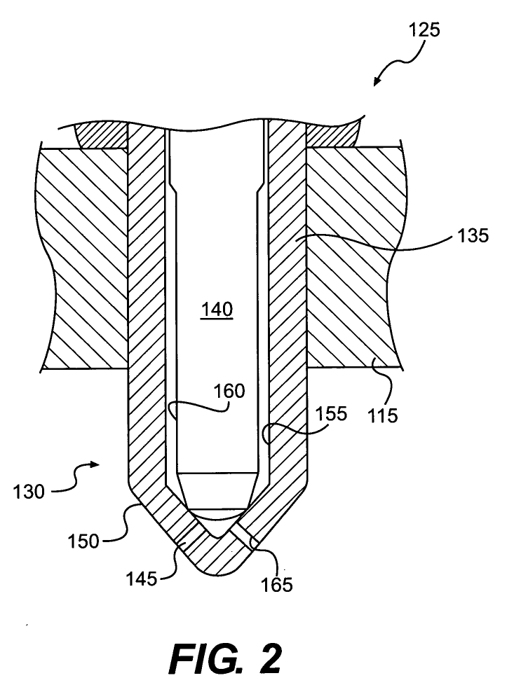

Referring to FIG. 2, exposed portion 130 may include a body portion 135 and a needle 140 of fuel injector 125. Needle 140 may be part of a valve assembly and may be movably supported within body portion 135. Needle 140 may displace from a first position, blocking fuel flow into combustion chamber 120, to a second position, allowing fuel flow from fuel injector 125 into combustion chamber 120 via one or more orifices 145 disposed in body portion 135. Body portion 135, needle 140, and orifices 145 may all be exposed to high temperatures and high pressures from combustion chamber 120. Additional components of fuel injector 125 may also be exposed to high temperatures and high pressures.

Body portion 135 and/or needle 140 may be made from a maraging steel. As is known in the art, the maraging steel is an iron-based alloy that may undergo a martensitic transformation. The martensitic transformation may be followed by age or precipitation hardening that may increase strength, ductility, and toughness of the maraging steel. Body portion 135 and/or needle 140 may be made from any suitable maraging steel such as, for example, C-300 or C-350 maraging steel. Body portion 135 and/or needle 140 may alternatively be made from AerMet alloys 310 or 340. It is contemplated that additional components of fuel injector 125 may be made from maraging steel.

Maraging steel for body portion 135 and/or needle 140 may be subjected to vacuum induction melting and vacuum arc remelting to reduce oxide content in the steel. Vacuum induction melting may include melting metal within an airtight water-cooled steel furnace under vacuum conditions via an induction of electrical eddy currents. Vacuum arc remelting may include a drop-by-drop melting and casting in a vacuum-sealed furnace. Vacuum induction melting and vacuum arc remelting may remove undesirable gases such as oxygen, nitrogen, and hydrogen, and each process may have a duration such as, for example, of up to about 24 hours. Vacuum induction melting and vacuum arc remelting may lower the probability of subsurface fatigue crack initiation in the steel.

Body portion 135 and/or needle 140 may alternatively be made from a carburizing steel. As is known in the art, carbon may be added to low-carbon steels at high temperatures such as, for example, 850° to 950° Celsius to form the carburizing steel. Body portion 135 and/or needle 140 may be made from any suitable carburizing steel such as, for example, Ferrium C61. It is contemplated that additional components of fuel injector 125 may be made from carburizing steel.

In addition to being made from maraging steel or carburizing steel, body portion 135 and/or needle 140 may be nitrided to provide compressive residual stresses. The combination of nitriding with maraging or carburizing steel may produce a unique reaction in a surface layer. Nitriding a maraging steel or a carburizing steel may produce a surface layer having significantly higher beneficial compressive residual stresses than may be produced by nitriding conventional materials. The compressive residual stresses may resist fatigue stresses from high engine temperatures and pressures during a service life of fuel injector 125. As is known in the art, nitriding may be a thermochemical diffusion treatment that diffuses nitrogen into a surface of a ferrous material without changing the microstructure of the material. Nitriding may generally result in a layer of a nitrided component being a predominantly γ′ compound (Fe₄N), a predominantly ε compound (Fe₂₋₃N), or a mixture of γ′ and ε microstructures. An outer surface 150 of body portion 135, an inner surface 155 of body portion 135, a surface 160 of needle 140, and/or a surface 165 of orifices 145 may be nitrided. It is contemplated that additional components of fuel injector 125 may also be nitrided.

### INDUSTRIAL APPLICABILITY

The disclosed fuel injector may be used in any machine where fuel is injected at high pressure such as, for example, a machine having an internal combustion engine. The disclosed fuel injector may substantially resist failure at high temperatures and pressures in such machines.

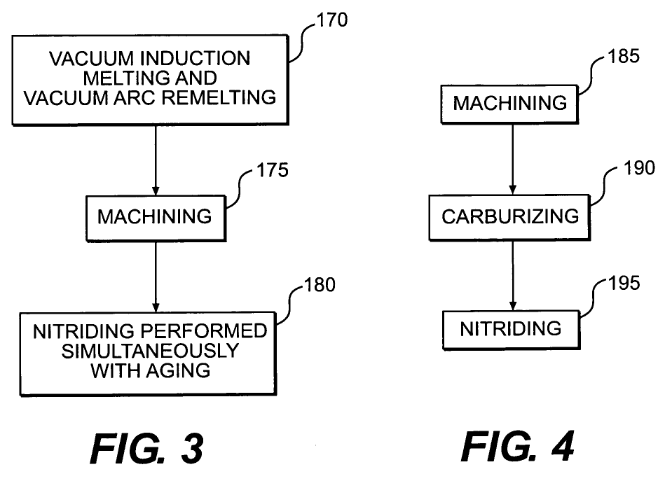

Components of fuel injector 125 that are exposed to combustion chamber 120 may be made from maraging steel and may be nitrided. As illustrated in FIG. 3, maraging steel for fuel injector 125 may undergo vacuum induction melting and vacuum arc remelting of components of fuel injector 125 in step 170. In step 175, components of fuel injector 125 may be machined such as, for example, a machining of one or more orifices 145. In step 180, components of fuel injector 125 may be nitrided, which may include performing nitriding at about 480° Celsius for about 24 hours. Fuel injector 125 may be subjected to nitriding in a nitriding furnace via a nitrogen-containing material such as, for example, ammonia. Alternatively, fuel injector 125 may be nitrided in a nitriding furnace via plasma-nitriding with nitrogen gas that is ionized. The nitriding of step 180 may be performed simultaneously with an aging of maraging steel components of fuel injector 125. Although step 175 may be ideally performed before step 180, it is also contemplated that step 175 may be performed after step 180.

As noted above, components of fuel injector 125 that are exposed to combustion chamber 120 may alternatively be made from carburizing steel and may be nitrided. As illustrated in FIG. 4, carburizing steel components for fuel injector 125 may undergo machining in step 185 such as, for example, a machining of one or more orifices 145. In step 190, components of fuel injector 125 may be carburized, which may include performing carburizing for a suitable duration such as, for example, about 4 hours. The carburizing of step 190 may be performed following the machining of step 185. In step 195, which may follow the carburizing of step 190, components of fuel injector 125 may be nitrided, which may include performing nitriding at about 480° Celsius for between about 16 and 24 hours.

Components of fuel injector 125 made from carburized or maraging steel, and nitrided according to the disclosed method, may provide a fuel injector capable of withstanding high temperatures and pressures associated with internal combustion engines. Fuel injector 125 may thus substantially resist fatigue failure at such high temperatures and pressures.

It will be apparent to those skilled in the art that various modifications and variations can be made to the disclosed materials. Other embodiments will be apparent to those skilled in the art from consideration of the specification and practice of the disclosed method and apparatus. It is intended that the specification and examples be considered as exemplary only, with a true scope being indicated by the following claims and their equivalents.

What is claimed is:

1. A fuel injector, comprising:
an injector body; and
an injector needle located inside the injector body;
at least one of the injector body and injector needle having a portion configured to be exposed to a combustion chamber, the portion including maraging or carburizing steel and having a nitrided outer layer.

2. The fuel injector of claim 1, wherein the portion includes maraging steel and the maraging steel is C-300 maraging steel or C-350 maraging steel.

3. The fuel injector of claim 1, wherein the portion includes carburizing steel and the carburizing steel is Ferrium C61 carburizing steel.

4. The fuel injector of claim 1, wherein both the injector body and the injector needle include a portion including maraging or carburizing steel and having a nitrided outer layer.

5. A direct injection nozzle of a direct injection fuel injector, comprising:
a direct injection nozzle body portion; and
a direct injection orifice;
at least one of the nozzle body portion or the orifice having a nitrided outer layer.

6. The direct injection nozzle of claim 5, wherein the direct injection nozzle includes maraging or carburizing steel.

7. The direct injection nozzle of claim 6, wherein the nozzle body includes a portion including maraging steel, carburizing steel, or AerMet alloy and having a nitrided outer layer.

8. A method for processing a fuel injector component, comprising:
machining at least a portion of a fuel injector component formed of maraging steel; and
nitriding the fuel injector component during an aging process.

9. The method of claim 8, wherein nitriding the fuel injector component is performed at about 480° Celsius for about 24 hours.

10. The method of claim 8, wherein machining the fuel injector component is performed prior to nitriding the fuel injector component.

11. The method of claim 8, further including subjecting the maraging steel of the fuel injector component to vacuum induction melting and vacuum arc remelting.

12. The method of claim 8, wherein the maraging steel is C-300 maraging steel or C-350 maraging steel.

13. The method of claim 8, wherein the maraging steel is strengthened by a martensitic transformation and precipitation hardening.

14. A method for processing a fuel injector component, comprising:
carburizing a steel fuel injector component; and
nitriding the fuel injector component after the carburizing.

15. The method of claim 14, wherein nitriding the fuel injector component is performed at about 480° Celsius for between about 16 and 24 hours.

16. The method of claim 14, wherein nitriding the fuel injector component is performed following carburizing the fuel injector component.

17. The method of claim 14, wherein the fuel injector component is made from Ferrium C61 carburizing steel.

18. The method of claim 14, further including machining at least a portion of the fuel injector component.

19. The method of claim 14, wherein carburizing the fuel injector component is performed following the machining of the fuel injector component.

20. The method of claim 14, wherein carburizing may be performed for about 4 hours.
